(19) United States
(12) Patent Application Publication
(10) Pub. No.: US 2004/0240543 A1
(43) Pub. Date: Dec. 2, 2004

(54) Low bandwidth video compression

(76) Inventor: Yves C. Faroudja, Los Altos Hills, CA (US)

Correspondence Address: Gallagher & Lathrop, Suite 1111, 601 California Street, San Francisco, CA, 94108-2805, US

(21) Appl. No.: 10/487,723

(22) PCT Filed: Sep. 4, 2002
(86) PCT No.: PCT/US02/28254

Related U.S. Application Data
(60) Provisional application No. 60/317,387, filed on Sep. 4, 2001.

(51) Int. Cl. H04N 7/12

(52) U.S. Cl. 375/240.01; 375/240.25

(57) ABSTRACT

In one embodiment, a low bandwidth encoder extracts edge transitions to provide a video signal mainly representing image contours. The contours' amplitude and width may be standardized. Significant points along the contours are extracted as nodes to provide a first encoder output layer. A low-resolution, essentially contour-free video signal representing the image provides a second encoder output layer. For a moving image, the frame rate of the layers may be reduced. In one embodiment, a decoder receives the first and second layers and derives a video signal representing contours by space-domain interpolating the nodes signal. The resulting contours video signal and low-resolution, essentially contour-free video signal are multiplicatively or pseudo-multiplicatively combined to provide an output approximating the original input signal. For a moving image, morphing reference points derived from frames of the nodes video signal are used to provide time-domain interpolation before or after multiplicative or pseudo-multiplicative combining.

### TECHNICAL FIELD

The invention relates to video compression. More particularly, the invention relates to a video compression system, encoder, decoder and method providing a very low bandwidth or data rate for use, for example, on the Internet. Aspects of the invention are applicable to both still and motion video.

### BACKGROUND ART

New applications in the video area are increasingly demanding in terms of bandwidth utilization. The Internet, for example, makes every day a greater use of video, as it is expected that films and other video programs are to be accessible in the home via the Web with a reasonable quality.

The commonly practiced strategy to attempt to satisfy the users has been based on three points.

(1) Accept an image quality degradation, reduced resolution, reduced size, lower number of frames/sec (motion discontinuity) less progressive, more brutal degradation when the network is overloaded—increased loading time.

(2) Increase in available bandwidth by making more spectrum available for Internet communications.

(3) Increased performances of compression schemes based on Discrete Cosine Transform (DCT) process such as MPEG. (MPEG-1, -2 and -4).

For that matter a newer compression standard, such as MPEG 4, which uses an object-based approach, shows some very clear promises, even though its complexity at the receiving station end may not make it very practical at the present time.

The combination of these approaches 1, 2 and 3 gives a result that is just above the threshold of pain. The picture is just good enough, the downloading time just acceptable, the bandwidth cost just affordable. A different approach is therefore required if future needs of the public are to be met.

In theory, there is no reason for video bandwidth to be very large, as the information content is often not much more significant than its accompanying audio.

If a proper understanding of the image and its evolution through time were obtained, and then a simple description (semantics) carried through—with numerical equivalent of words in the transmission path, the bandwidth needs would be extremely reduced.

A sentence such as: “Draw a redwood tree, 30 feet tall, on a blue sky background seen from a camera located 60 feet away, and move closer to the tree at such and such speed, with an objective lens of such angle” would take much less bits than carrying the picture. However, such an approach, ideally suited to the nature of images, is not for the time very, very practical, as it requires at both ends a very heavy store of pictures most commonly transmitted, a very large memory at the display end to store and “translate” the image, and quite a complex set of instructions to cover all cases of images.

Presented herein is an approach, which is intermediate between the present state of the art (brute force, but increasingly performing compression) and the futuristic ideal approach: semantic description of image sequences.

The present invention mimics the approach taken by mankind from time immemorial to represent images. Television uses scanning lines to duplicate an object. These lines are scanned from left to right and from top to bottom. The reason to do so is cultural or historical. Early industrialized countries, where television was developed, wrote their respective language from left to right, and top to bottom. Early mechanical television used a Nipkow disc to observe and display the picture, because it was simple and convenient. Electronic television grew upon this heritage, and kept a lot of the features that were relevant in the 1920's and possibly are not in the 21^{st} century.

Furthermore, the time-domain sampling of a moving object, the division of the television stream into successive frames, blended onto each other by the persistence of luminous impressions on the retina, was probably inspired by cinema.

Again, there is no fundamental reason to sample an image at a fixed rate in the time domain, and to carry these successive information in the transmission path, even if, presently, compression processes do not duplicate and transmit the successive parts of the image that do not need to be repeated.

Much before television, cinema and photography were invented, people used quite a different approach to represent stationary pictures and moving scenes. This approach, used since prehistoric times, was (and is) intrinsically very simple: the artist draws the outline of the object (example—a bison on a cave wall) and then fills the object with a corresponding color. The communication with the viewer (even 20,000 years later) is excellent. There is no doubt that the animal drawn in the cave is a bison. The artist had an understanding of the nature of the object, and such understanding was, or is, communicated very efficiently to the viewer.

Bandwidth requirements for an object represented by its outline and painted, as it were, by “numbers” are extremely low.

If the object is in motion, a good example of old-time motion communication is the puppet show. Here again the bandwidth requirements are very low. The motion of a puppet is quite good with 5 to 10 wires occupying in space 10 to 100 positions.

### DISCLOSURE OF THE INVENTION

Aspects of the invention include an encoder, a decoder and a system, comprising an encoder and a decoder. According to one aspect of the invention, the encoder separates an input video signal representing an image (hereinafter referred to a “full-feature image”) into two or three components:

(a) a low resolution signal representing a full color, full gray scale image (hereinafter referred to as a “low resolution image”) (this information may be carried in a first or main layer, channel, path, or data stream (hereinafter referred to as a “layer”);

(b) a signal representing the image's edge transitions (hereinafter referred to as “contours”) by means of their significant points (hereinafter referred to as “nodes) (this information may be carried in a second or enhancement layer); and

(c) optionally, an error signal to assist a decoder in re-creating the original full-feature image (this information may be carried in a third layer).

The video signal may represent a still image or a moving image, in which case the video signal and the resulting layers may be represented by a series of frames. The input video signal to the encoder may have been preprocessed by conventional video processing that includes one or more of coring, scaling, noise reduction, de-interlacing, etc. in order to provide an optimized signal free of artifacts and other picture defects.

The decoder utilizes the two or three layers of information provided by the encoder in order to create an approximation of the full feature image present at the encoder input, desirably an approximation that is as close as possible to the input image.

The steps for processing the first or main layer in the encoder may include:

a) bi-dimensional (horizontal and vertical) low-pass filtering to provide large areas information with low resolution and a low bit rate;

b) (in the case of a moving image video input) time domain decimation (frame rate reduction) to select large areas information frames (the relevant frames are selected from the same input frame in all layers); and

c) compressing the resulting data and applying it to a transmission or recording path.

The data is received by a decoder and is decompressed and processed in order to re-create the large areas information.

The steps for processing the second or enhancement layer and for combining the first and second layers may include:

a) extraction of contours (edge transitions) from the video image by using any well-known video processing techniques such as bidimensional (horizontal and vertical) second differentiation or by any other well-known edge detection techniques (various contour (edge transition) detection techniques are described, for example, in the Handbook of Image & Video Processing by Al Bavik, Academic Press, San Francisco, 2000);

b) extraction and identification of significant points (hereinafter referred to as “nodes”) along contours, by use of recognizable picture (image) events (for example, as described below) and, optionally, comparison to a dictionary or catalog of images coupled to their corresponding nodes (each “word” of the dictionary is composed of the dual information: full-feature image and corresponding node pattern.);

c) recognition and specific coding of unusual events or sequences, such as inflection points on a curve, sudden changes of motion, out of focus areas, fade-and-dissolve between scenes, changes of scene, etc.

d) time domain decimation (frame rate reduction) (the key frames being selected from the same input frame in all layers);

e) optionally, ranking of nodes according to a priority of significance so that bandwidth adaptivity may be achieved by ignoring less significant nodes; and

f) compressing the resulting data and applying it to a transmission or recording path.

The data is received by a decoder and is decompressed and processed in order to re-create the contours information. Decompression results in node data recovery, (node data recovery re-creates nodes constellations with their nodes properly identified and having defined spatial (horizontal and vertical) coordinates).

Processing in the decoder may include:

g) (optionally) taking into consideration the levels of priority of the recovered nodes if bandwidth limitations require it; and

h) interconnection of nodes on a given contour by interpolation (the interpolation process preferably is non-linear by using more than two nodes as a reference (for example, four) in order to re-create points on the contour located between nodes, and to better approximate the original contour than in the case of a two-nodes interpolation).

According to one alternative, the decoded low frame rate low-resolution large-areas main layer is combined with the decoded identically low frame rate contours enhancement layer by a multiplicative process or pseudo-multiplicative process in order to obtain a reasonable facsimile of the full feature image present at the input of the encoder, but at a lower frame rate. “Multiplicative process” and “pseudo-multiplicative process” are defined below.

Optionally, the frame rate of the lower-frame-rate facsimile of the full feature image present at the encoder may be increased. Such processing may include:

i) time domain interpolation of the low-frame-rate nodes obtained by the node data recovery (g, just above) to recreate a high-frame-rate nodes constellation (as explained further below, time-domain interpolation using more that two references frames, such as four, is preferred for adequate motion fluidity);

j) using the recreated high-frame-rate nodes as morphing reference points to increase the frame rate of the lower-frame-rate facsimile of the full-feature image (obtained by the multiplicative or pseudo-multiplicative combination) by morphing between successive frames.

Alternatively, morphing may be performance separately in the main and enhancement layers prior to the multiplicative or pseudo-multiplicative combining. In that case, the combining takes places at a high frame rate.

The steps for processing the optional third or error layer in the encoder may include:

a) as part of the encoder, providing a decoder substantially identical to a decoder used for decoding the main and enhancement layers after transmission and recording;

b) after proper delay matching, subtracting the output of the decoder provided in the encoder from the input signal, thus generating an error signal;

c) compressing the resulting data and applying it to a transmission or recording path.

If available, the decoder may recover and decompress the error layer and then combine it with the combined main and enhancement layers to obtain an essentially error free re-creation of the input signal applied to the encoder.

According to other aspects of the invention, a “contours” only output is obtained from the encoder. This may be because the encoder is capable of providing only a single layer output, the layer referred to above as the “second” or “enhancement” layer, and/or (a) the decoder is capable of recovering multiple layers but only receives a “contours” layer (for example, because the encoder is only providing a single “contours” layer or because of bandwidth limitations in the recording or transmission medium), or (b) the decoder is capable of recovering only the “contours” layer.

When the available bandwidth or bit rate is very low, it might be aesthetically preferable to display only the contours of an object instead of a full-feature image of such objects having artifacts associated with the low bit rate such as quantizing error noise, low resolution, artifacts of different nature, etc. The bit rate requirement for the transmission of contours is very low, and aesthetically pleasing images are acceptable even with very narrow bandwidth channels. The processing for “contours” only encoding and decoding is generally the same as processing for the contours layer (enhancement layer) described above.

### DESCRIPTION OF THE DRAWINGS

FIG. 1 is a conceptual and functional block diagram of a contours extractor or contours extraction function in accordance with an aspect of the present invention.

FIG. 2 is a series of idealized time-domain waveforms in the horizontal domain, showing examples of signal conditions at points A through F of FIG. 1 in the region of an edge of an image. Similar waveforms exist for the vertical domain.

FIGS. 3A-C are examples of images at points A, D and, E, respectively, of FIG. 1.

FIG. 4A shows a simplified conceptual and functional block diagram of an encoder or encoding function that encodes an image as nodes representing contours of the image according to an aspect of the present invention.

FIG. 4B shows a simplified conceptual and functional block diagram of a decoder or decoding function useful in decoding contours represented by their nodes according to an aspect of the present invention.

FIG. 5A is an example of an image of a constellation of nodes with their related contours.

FIG. 5B is an example of an image of a constellation of nodes without contours.

FIG. 6 shows a simplified conceptual and functional block diagram of a full-picture encoder or encoding function according to another aspect of the present invention.

FIG. 7 shows a simplified conceptual and functional block diagram of a full-picture decoder or decoding function according to another aspect of the present invention.

FIG. 7A shows a simplified conceptual and functional block diagram of a pseudo-multiplicative combiner or combining function usable in aspects of the present invention.

FIG. 7B is a series of idealized time-domain waveforms in the horizontal domain, showing examples of signal conditions at points A through H of FIG. 7A in the region of an edge of an image. Similar waveforms exist for the vertical domain.

FIG. 7C shows a simplified conceptual and functional block diagram of a full-picture decoder or decoding function according to another aspect of the present invention that is a variation on the full-picture decoder or decoding function of FIG. 7.

FIG. 8A shows a simplified conceptual and functional block diagram of an encoder or encoding function embodying a further aspect of the present invention, namely a third layer.

FIG. 8B shows a simplified conceptual and functional block diagram of a decoder or decoding function complementary to that of FIG. 8A.

### BEST MODE FOR CARRYING OUT THE INVENTION

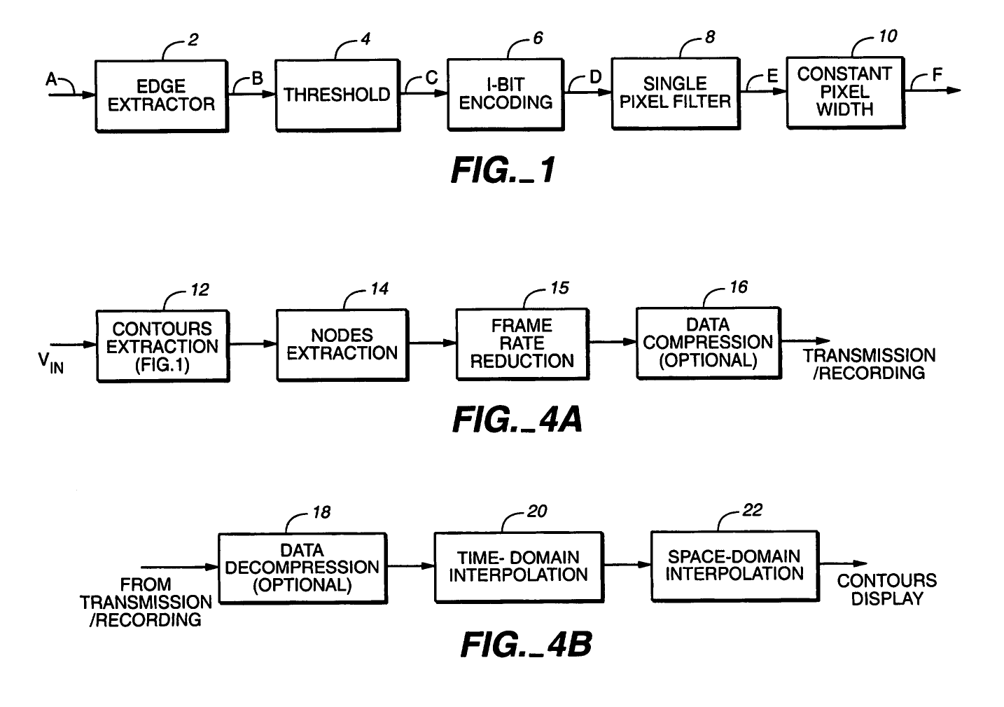

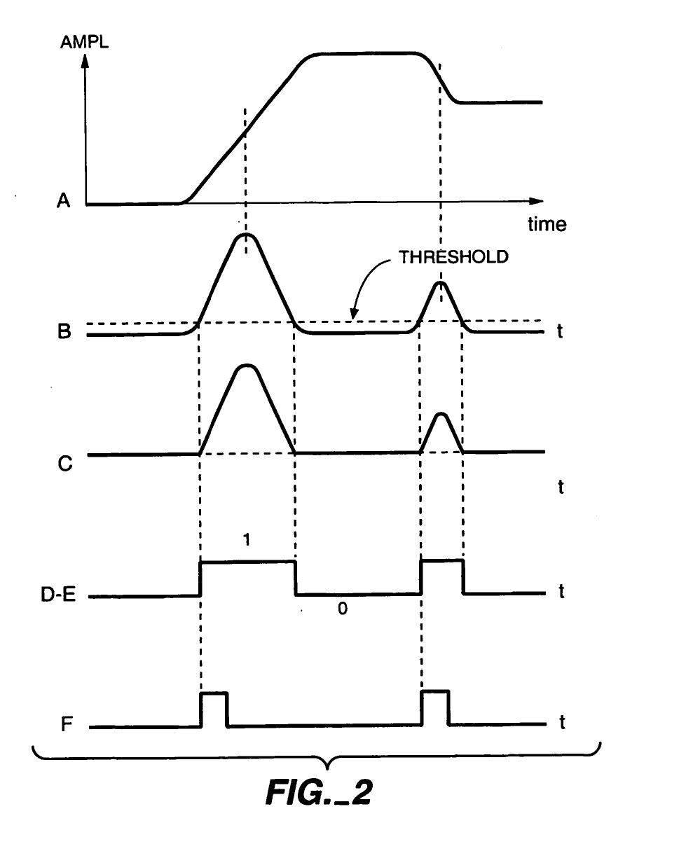

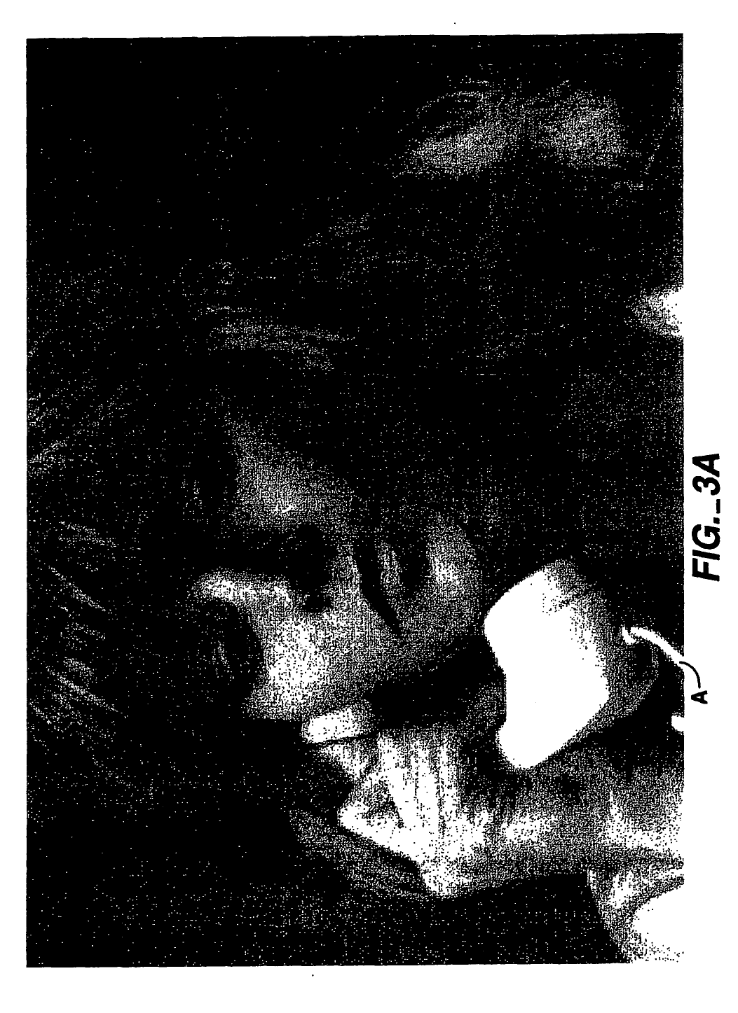

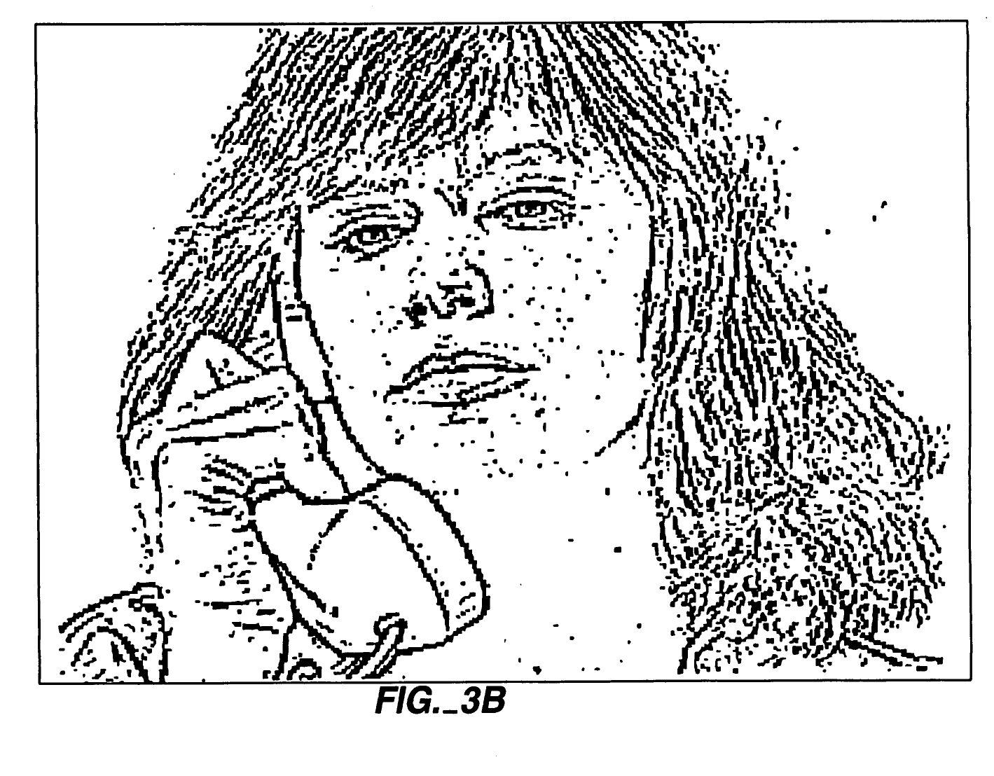

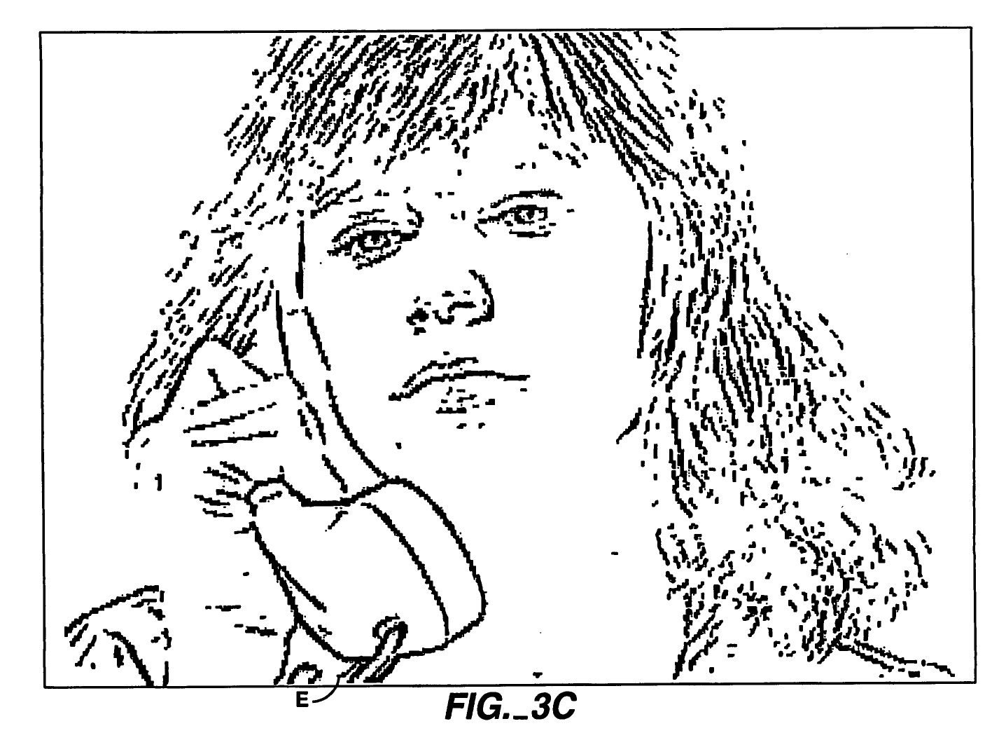

FIG. 1 is a conceptual and functional block diagram of a contours extractor or contours extraction function in accordance with an aspect of the present invention. FIGS. 2 and 3A-C are useful in understanding the operation of FIG. 1. The overall effect of the contours extractor or contours extraction function is to reduce substantially the bandwidth or bit rate of the input video signal, which, for the purposes of this explanation, may be assumed to be a digitized video signal representing a moving image or a still image defined by pixels.

Referring now to FIGS. 1, 2 and 3A-3C, an input video signal is applied to a bi-dimensional (horizontal and vertical) single-polarity contour extractor or extraction function 2. “Single-polarity” means that the contour signal is only positive (or negative) whether the transition is from black to white or white to black. The extractor or extractor function 2 extracts edge transition components of the video signal representing contours of the image so as to reduce or suppress other components of the video signal, thereby providing a video signal mainly representing contours of the image. An example of an input image at point A is shown in FIG. 3A. An example of a waveform at point A in the region of an image edge is shown in part A of FIG. 2. Many known prior art edge, transition, and boundary extraction techniques are usable, including for example those described in the above mentioned Handbook of Image & Video Processing and in U.S. Pat. Nos. 4,030,121; 5,014,113; 5,237,414; 6,088,866; 5,103,488; 5,055,944; 4,748,675; and 5,848,193. Each of said patents is hereby incorporated by reference in its entirety. Typically, in the television arts, an image edge is detected by taking the second differential of the video signal, the last stage or function of block 2 is a rectifier sign remover, and the edge transition output waveform (part B of FIG. 2) is a multi-bit signal.

The output of block 2 is applied to a threshold or thresholding function 4, which is used to reduce noise components in the video signal. For example, if the threshold is set as shown in part B of FIG. 2, the output of block 4 is as shown in part C of FIG. 2—low-level noise is removed.

The noise-reduced video signal representing contours of the image is then processed so as to standardize one or more of the characteristics of the video signal components representing contours. One of the characteristics that may be standardized is the amplitude (magnitude and sign or polarity) of the video signal components representing contours. Another one of the characteristics that may be standardized is the characteristics of the video signal components representing the width of the contours. The exemplary embodiment of FIG. 1 standardizes both of the just-mentioned characteristics to provide contours made of contiguous linear elements that are one bit deep (amplitude defined by one bit) and one pixel wide.

The amplitude (magnitude and sign or polarity) of the thresholded video signal is substantially standardized by reducing or suppressing amplitude variations of the components of the video signal representing contours. Preferably, this is accomplished by applying it to a 1-bit encoder or encoding function 6. The 1-bit encoding eliminates amplitude variations in the extracted edge transition components and in the other components of the video signal. For example, each pixel in the image may have an amplitude value of “0” or “1”—in which “0” is no transition component and “1” is presence of transition components (or vice-versa). Part D-E of FIG. 2 shows the waveform at point D, the output of block 6. FIG. 3B shows an example of the image at point D.

The contour-amplitude-standardized video signal may then be bi-dimensionally filtered to reduce or suppress single pixel components of the video signal. Pixels that are single from the point of view of bi-dimensional space are likely to be false indicators. Elimination of such single pixels may be accomplished by applying the video signal to a single pixel bi-dimensional filter or filtering function 8. The purpose of the filter is to eliminate single dots (single pixels) that are incorrectly identified as transitions in the video image. Block 8 looks in bi-dimensional space at the eight pixels surrounding the pixel under examination in a manner that may be represented as follows:

| | | |
|---|---|---|
| X | X | X |
| X | + | X |
| X | X | X |

If all pixels are white (=0), then the center pixel at the output of block 8 will be white. If any of the surrounding pixels is black (=1), then the center pixel keeps the value it had at the input (black or white). Although the waveform appears the same at the input and output of block 8 (part D-E of FIG. 2), the images at points D and E appear different visually as shown in the examples of FIGS. 3B and 3C. In FIG. 3C, extraneous dots in the picture have been removed—the single-pixel filter eliminates most of the residual image noise, appearing in the image at the output of block 6 “D” (FIG. 1) as isolated dots. Alternatively, another type of image noise reducers may be employed. Many suitable image noise reducers are know in the art.

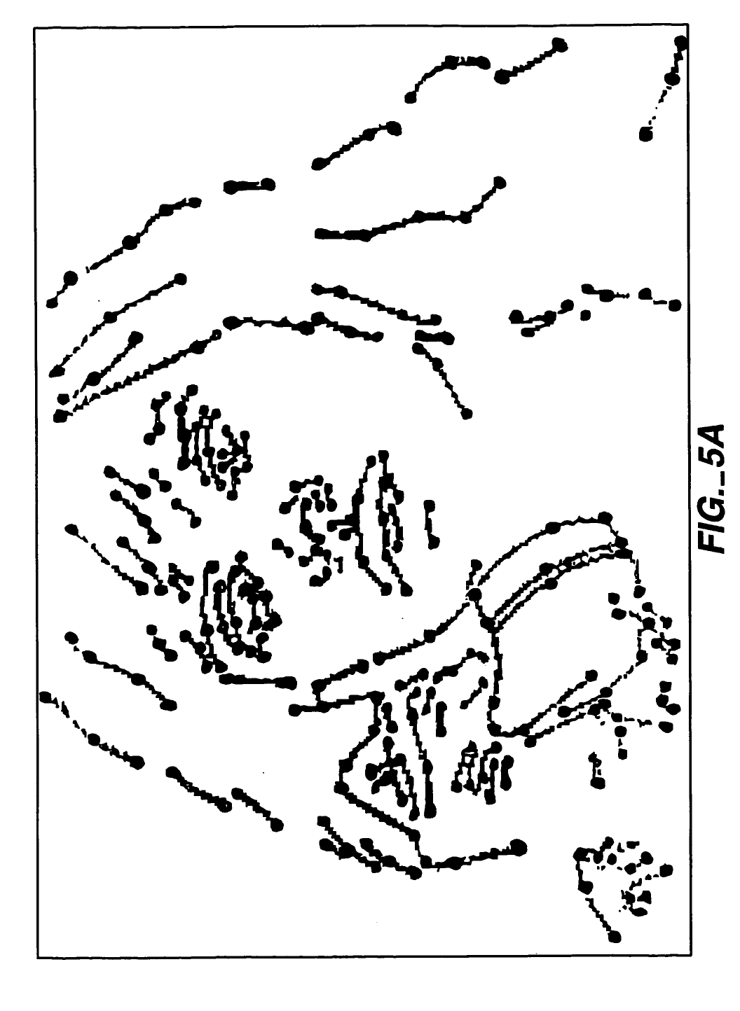

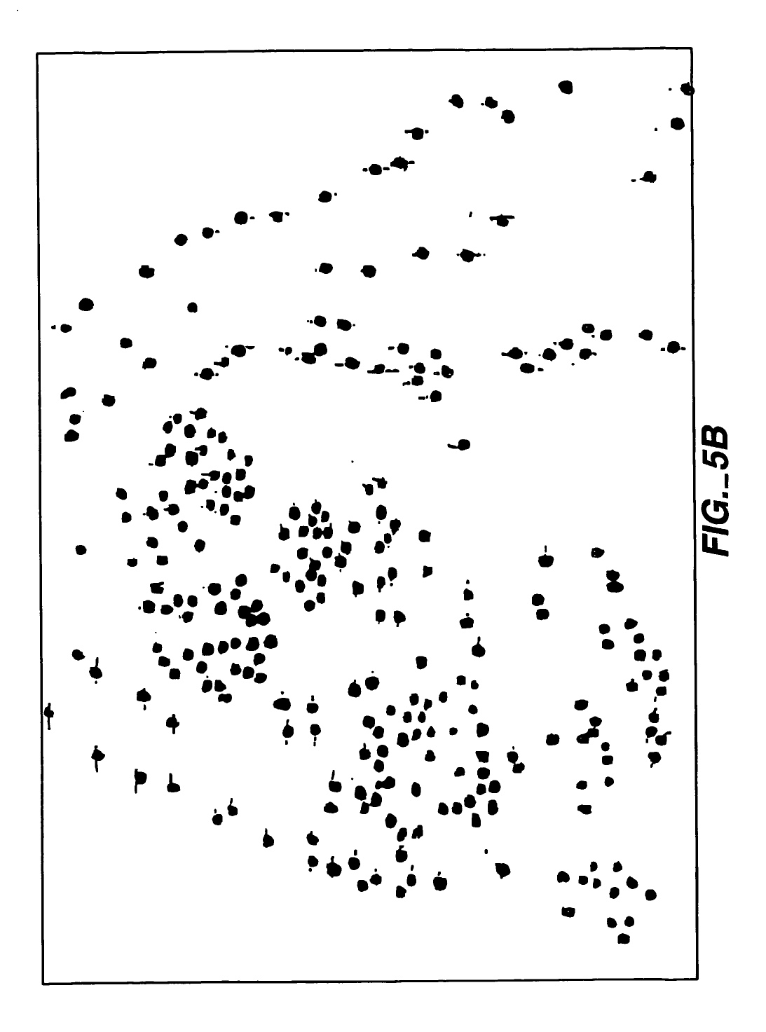

The output of block 8 may then be applied to a further video signal edge component standardizer, a processor or processor that substantially standardizes the characteristics of the video signal components representing the width of contours, thereby providing a video signal representing contours of the image in which the width of contours is substantially standardized, for example, so that the width of contours is substantially constant. This may be accomplished by applying the video signal to a constant pixel width circuit or function 10. Part F of FIG. 2 shows its effect on the example waveform. The constant pixel width block standardizes the transition width to a fixed number of pixels, such as one pixel-width (i.e., it operates like a “one-shot” circuit or function). Although two, three or some other number of pixels is usable as a fixed pixel width, a pixel width of one is believed to provide better data compression than a larger number of pixels. The fixed pixel width output of FIG. 1 constitutes points along contours. Each point is a potential node location. However, as described further below, only the significant points are subsequently selected as nodes. See, for example, FIG. 5B as described below.

FIG. 4A shows a simplified conceptual and functional block diagram of an encoder or encoding function that reduces the bandwidth or bit rate of a video signal representing an image by providing a video signal mainly representing nodes. A video input signal is applied to a contours extractor or extraction function 12. Block 12 may be implemented in the manner of FIG. 1 as just described to provide a video signal mainly representing contours of the image. The output of block 12 is applied to a nodes extractor or extraction function 14. Block 14 extracts components of the contours video signal representing nodes along contours of the image so as to reduce or suppress other components of the video signal, thereby providing a video signal mainly representing nodes. Thus, the nodes themselves comprise compressed data The extraction of nodes may be performed, for example, in the manner of the techniques described in U.S. Pat. Nos. 6,236,680; 6,205,175; 6,011,588; 5,883,977; 5,870,501; 5,757,971; 6,011,872; 5,524,064; 6,011,872; 4,748,675; 5,905,502; 6,184,832; and 6,148,026. Each of these patents is incorporated herein by reference in its entirety. Optionally, nodes extraction may be supplemented by comparison with images in a dictionary, as explained below. The nodes extractor or extractor function 14 associates each extracted node with a definition in the manner, for example, of the definitions a through d listed below under “B”, which information is carried, for example, in numerical language, with the nodes throughout the overall system. Thus, the output of block 14 is a set of numerical information representing a constellation of nodes in the manner of FIG. 5B. For reference, FIG. 5A shows such a constellation of nodes such as at the output of block 14 superimposed on contours as might be provided at the output of block 12.

As described below, compression (preferably lossless or quasi-lossless) optionally may be employed to further compress the node data (the representation of an image as nodes itself constitutes a type of data compression).

Suitable parameters for the selection and identification of nodes (in block 14) may include the following:

A. Nodes Selection

(1) Nodes are on a contour

(2) Nodes are defined on a contour where one or more significant events (recognizable picture or image events) occur on the contour or its environment. These may include:

a. Start of the contour

b. End of the contour

c. Significant change of curvature of the contour

d. Change in environment (gray level, color, texture) in the vicinity of the contour.

e. Distance from the prior node on given contour exceeds a pre-determined value.

B. Node Numerical Definition (node attributes)

a. Node identification number

b. Contour identification number

c. Spatial coordinates

d. Significant event number (a number identifying a particular type of significant event giving rise to a node such as those events listed under A.(2)(a.-e.) above

Preferably, a given node keeps its identification number from frame to frame when its coordinates change (motion) in order to allow time-domain decimation (frame rate reduction) and time-domain interpolation in the decoding process.

C. Node Elimination

If a node location may be accurately predicted through interpolation of the four neighboring (adjacent consecutive) nodes on the same contour, such a node may be eliminated.

D. Nodes Dictionary

For non-real time applications, a dictionary of commonly occurring images may be employed. Each “word” or definition of this dictionary is composed of two parts:

1) the full-feature image itself, and

2) its nodes.

The mechanism of use of the dictionary is as follows:

1) the full-feature image being processed is compared to images in the dictionary using a suitable image matching scheme until the closest match is found; and

2) the nodes constellation of the reference image in the dictionary and of the image being processed are compared, and nodes of the image under process are modified, if necessary, to better match the reference nodes pattern of the dictionary. The dictionary may also include certain sequences of images undergoing common types of motion such as zooming, panning, etc.

E. Manual Nodes Choice

For non-real time applications the nodes may be manually determined.

F. Physical Nodes on Source

For teleconferencing application, specific dots not seen with a camera operating in the visible spectrum, but clearly perceived by a camera operating in the non-visible part of the optical spectrum (infra-red) may be applied directly on the subject to allow fast real time nodes extraction and image display.

The dictionary is not compiled in real time. Nodes may be selected automatically. The automatic selection may be enhanced manually. Alternatively, node selection may be done manually.

Dictionaries of objects, shapes or waveforms are known in the prior art. See, for example, U.S. Pat. Nos. 6,088,484; 6,137,836; 5,893,095; 5,818,461, each of which is hereby incorporated by reference in its entirety. Unlike the prior art, this aspect of the present invention employs a dictionary of images coupled with their nodes, thus facilitating the nodes extraction for the image to be processed by comparing it to the dictionary reference image.

The dictionary of images may be employed by using any of many known image recognition techniques. The basic function is to determine which dictionary “image” is the closest to the image being processed. Once an image is selected, if a node is present in the dictionary, but not in the corresponding constellation of nodes representing an image in the encoder, it may be added to the image being processed. If nodes of the image being processed do not have a corresponding one in the dictionary image, they may be removed from the image being processed.

Under conditions in which the bandwidth or bit rate is severely limited, it may be desirable to assign a top priority ranking to nodes considered to be more relevant to image re-creation than to others. A simple way to do so is to randomly assign a top priority ranking to one node out of every two or three, etc. A more sophisticated way to prioritize nodes is to assign a top priority ranking to nodes coincident with a selected one or ones of the significant events listed above.

The output of block 14 is applied to a conventional frame rate reducer or frame rate reduction function (time-domain decimator or decimation function) 15 that has the effect of lowering the frame rate when a moving image is being processed. Because individual nodes are clearly identified from frame to frame, it is unnecessary to transmit nodes every 24^{th} of a second. For example, in the case of film, a transmission at 4 or 6 FPS (frames per second) is sufficient because a subsequent interpolation, particularly four-point interpolation, can define the motion (even non-linear) with enough precision to regenerate the missing frames in the decoding process. An exceptional event (such as a sudden change of direction—tennis ball hitting a wall) preferably is identified, transmitted, and taken into account during the interpolation process in the decoder or decoding process. Frame rate reduction may be accomplished by retaining “key” frames that can be used to recreate deleted frames by subsequent interpolation. This may be accomplished in any of various ways—for example: (1) retain one key frame out of every 2, 3, 4, . . . n input frames on an arbitrary, constant basis, (2) change the key frame rate in real time as a function of the velocity of the motion sequence in process or the predictability of the motion, or (3) change the key frame rate in relation to dictionary sequences. The lowered frame rate nodes output of block 15 may be recorded or transmitted in any suitable manner. If sufficient bandwidth (or bit rate) is available, frame rate reduction (and frame rate interpolation in the decoder) may be omitted.

Optionally, prior to recording or transmission, the nodes extracted and identified by block 15 may be compressed (data reduced) by a compressor or compression function 16. A compression/decompression scheme based on nodes leads to higher compression ratios and ease of time-domain interpolation in the decoder, but other compression schemes, such as those based on the Lempel-Ziv-Welch (LZW) algorithm (U.S. Pat. No. 4,558,302). ZIP, GIF, PNG, are also usable in addition to the nodes extraction. Discrete Cosine Transform (DCT) based schemes such as JPEG and MPEG are not advisable, as they tend to favor DC and low frequencies, and transitions (edges) have a high level of high frequencies and compress poorly. Wavelets-based compression systems are very effective but difficult to implement, particularly with moving objects.

FIG. 4B shows a simplified conceptual and functional block diagram of a decoder or decoding function useful in deriving a video signal mainly representing contours of an image in response to a video signal mainly representing nodes of an image. The recorded or transmitted output of the encoder or encoding function of FIG. 4A is applied to an optional (depending on whether compression is employed in the encoder) decompressor or decompression function 18, operating in a manner complementary to block 16 of FIG. 4A. Block 18 delivers, in the case of a moving image, key frames, each having a constellation of nodes (in the manner of FIG. 5B). Each node has associated with it, in numerical language, a definition in the manner, for example, of the definitions a through d listed above under “B”. The output of block 18 is usable for time-domain interpolation and/or the re-creation of contours.

The output of block 18 is applied to a time-domain interpolator or interpolation function 20. The time-domain interpolator or interpolation function 20 may employ, for example, four-point interpolation. Block 20 uses the node identification and coordinate information of key frames from block 18 to create intermediate node frames by interpolation. As explained above, “key frames” are the frames that remain after the time domain decimation (frame rate reduction) in the encoder.

Because, in addition to its coordinates, each node has its own unique identification code, it is easy to track its motion by following the changes in its coordinates from frame to frame. The use of four-point interpolation (instead of two key point linear interpolation) allows proper interpolation when the motion is not uniform (i.e., acceleration).

Four-point interpolation may be applied both in the time domain (time-domain interpolation or frame rate reduction) and in the space (horizontal, vertical) domain (contours re-creation).

The common practice is to use a two-point linear interpolation. Consequently, in the time domain, the motion between two key frames is uniform and in the space domain, a contour is a succession of straight lines connecting successive nodes. Two-point interpolation is not satisfactory if a realistic recreation of the input image is desired; even in a limited bandwidth environment such as one in which aspects of the present invention operate.

A four-point interpolation is preferable. In the time domain, four successive key frames (two central key frames and two key frames occurring before and after the two central key frames) are utilized to define non-uniform motion between the two central key frames with a good precision, in agreement with the Nyquist criterion. The resulting more realistic, non-uniform motion helps the viewer to identify more closely the final result with the input signal.

However, in the case of a sudden motion change (example, a tennis ball hitting a wall) occurring during the four key frame interval, one or two key frames may be eliminated from the process of interpolation, thus leading to a temporary compromise where motion interpolation is not perfect before or after a sudden motion change. In the space domain, if the interpolation is to produce a contour that is not made of a succession of straight lines, more than two nodes are to be used to perform the interpolation. According to the Nyquist criterion, a minimum of four nodes is required to re-create a good approximation of the curvature of the original contour between the two central nodes in the sequence of four. The same restrictions as in the time domain apply when there is a sudden curvature change, an inflection point, or end of a contour.

In addition, a reference code is sent to inform the decoder when there is a sudden discontinuity in the motion flow, so that not all of the four key frames surrounding the frame under construction are utilized.

Block 22 performs in the bi-dimensional (horizontal and vertical) space domain the operation analogous to that performed by block 20 in the time domain. The contours in a given frame are recreated by interpolation between key nodes, identified as being in the proper order on a given contour. See, for example, the above-cited U.S. Pat. Nos. 6,236,680; 6,205,175; 6,011,588; 5,883,977; 5,870,501; 5,757,971; 6,011,872; 5,524,064; 6,011,872; 4,748,675; 5,905,502; 6,184,832; and 6,148,026. Here again, a four-point interpolation preferably is used in order to better approximate the contour curvature.

Contours are re-created from interpolated nodes and may be displayed. The output of block 22 provides a contours-only output signal that may be displayed. Alternatively, as described below, a video signal representing re-created contours of an image may be combined by multiplicative enhancement or pseudo-multiplicative enhancement with a video signal representing a low-resolution version of the image from which the contours were derived and nodes assisted morphing to generate and display a higher resolution image.

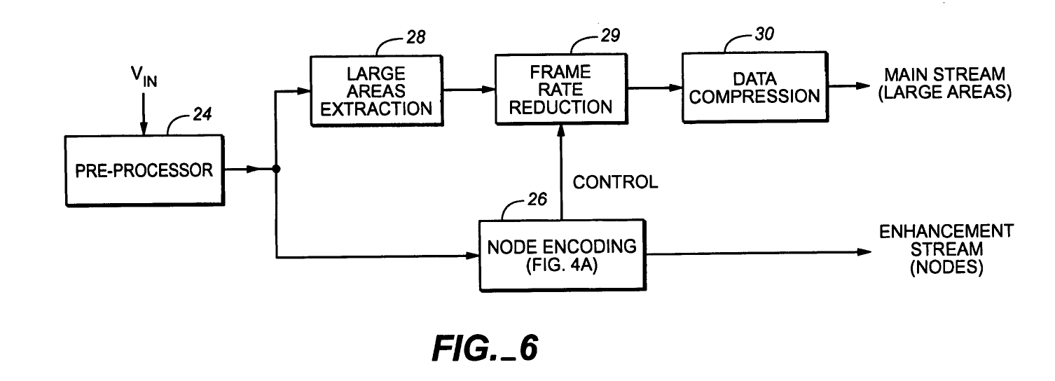

FIG. 6 shows a simplified conceptual and functional block diagram of a full-picture encoder or encoding function according to another aspect of the present invention. A pre-processor or pre-processing function 24 receives a video input signal, such as the one applied to the input of the FIG. 4A arrangement. The signal is pre-processed in block 24 by suitable prior art techniques to facilitate further processing and minimize the bit count in the compression process. There is a “catalog” of readily available technologies to do so. Among those are noise reduction, coring, de-interlacing/ine doubling, and scaling. One or more of such techniques may be employed. The output of the pre-processor 24 is applied to a nodes encoder or nodes encoding function 26 that includes the circuits or functions of FIG. 4A in order to produce an enhancement stream (nodes) video signal output. The output of the pre-processor 24 is also applied to a large areas extractor or extraction function 28. The basic component of block 28 is a bi-dimensional low pass filter. Its purpose is to eliminate, or, at least reduce, the presence of contour components in the video signal in order to provide a reduced bit rate or reduced bandwidth video signal representing a low-resolution, substantially contour-free version of the full-picture area of the input image with suppressed or reduced contours. The block 28 output is applied to a conventional frame rate reducer or frame rate reduction function (time-domain decimator or decimation function) 29. A control signal from block 26 informs block 29 as to which input frames are being selected as key frames and which are being dropped. The frame rate reduced output of block 29 is applied to a data compressor or compression function 30. Block 30 may employ any one of many types of known encoding and compression techniques. For reasons of compatibility with existing algorithms presently being used on existing communication networks, LZW based algorithms and DCT based algorithms (JPEG and MPEG) are preferred. The output of block 30 provides the main stream (large areas) output. Thus, two layers, paths, data streams or channels are provided by the encoding portion of the full picture aspect of the present invention. Those outputs may be recorded or transmitted by any suitable technique.

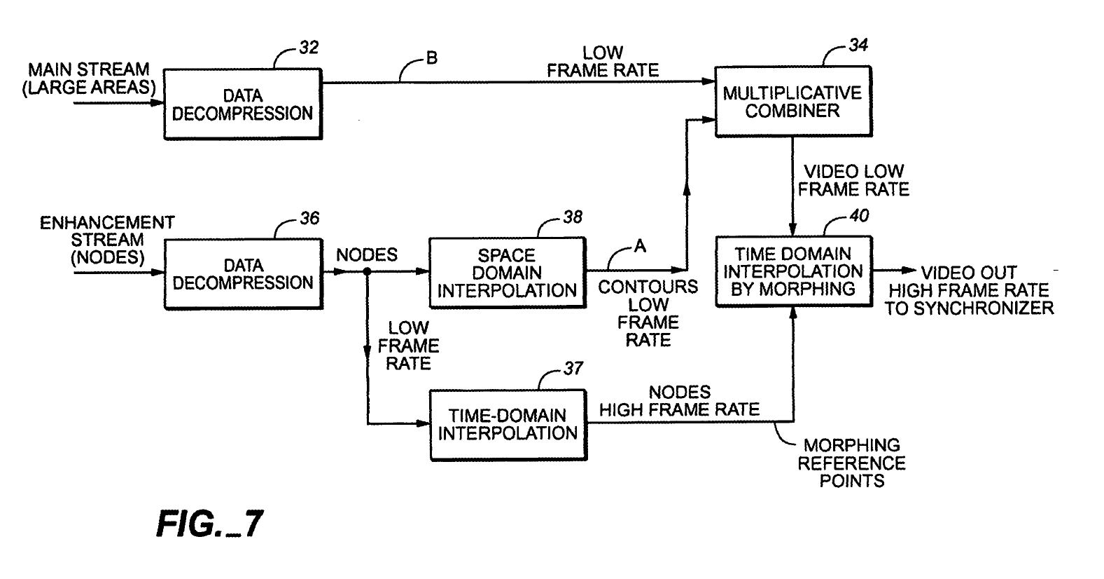

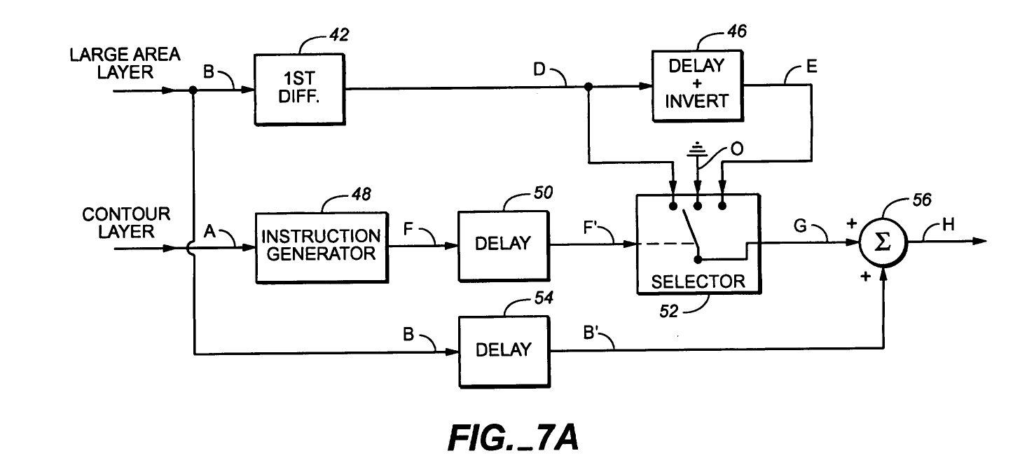

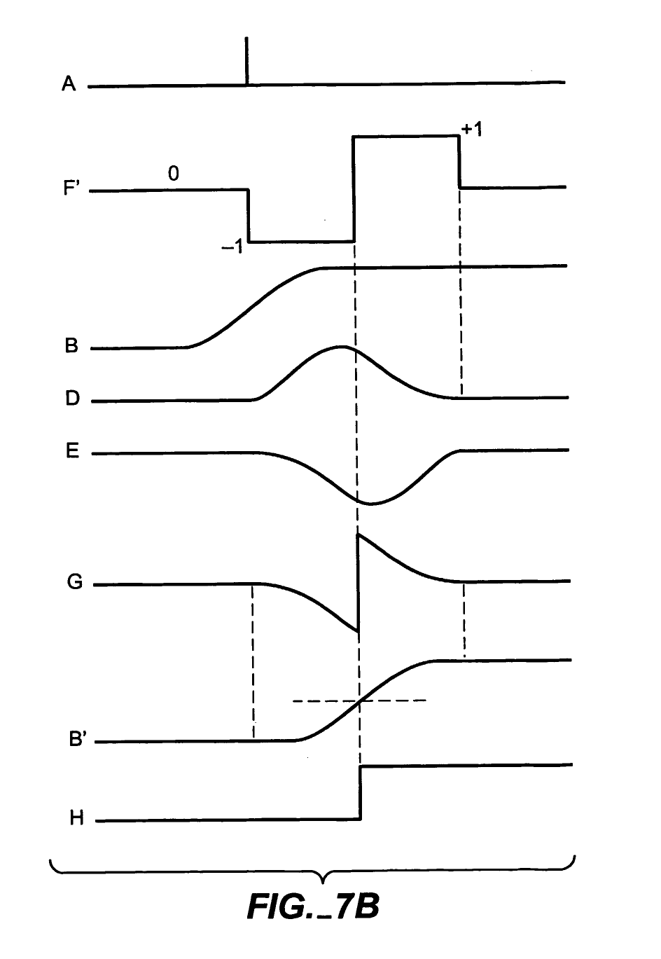

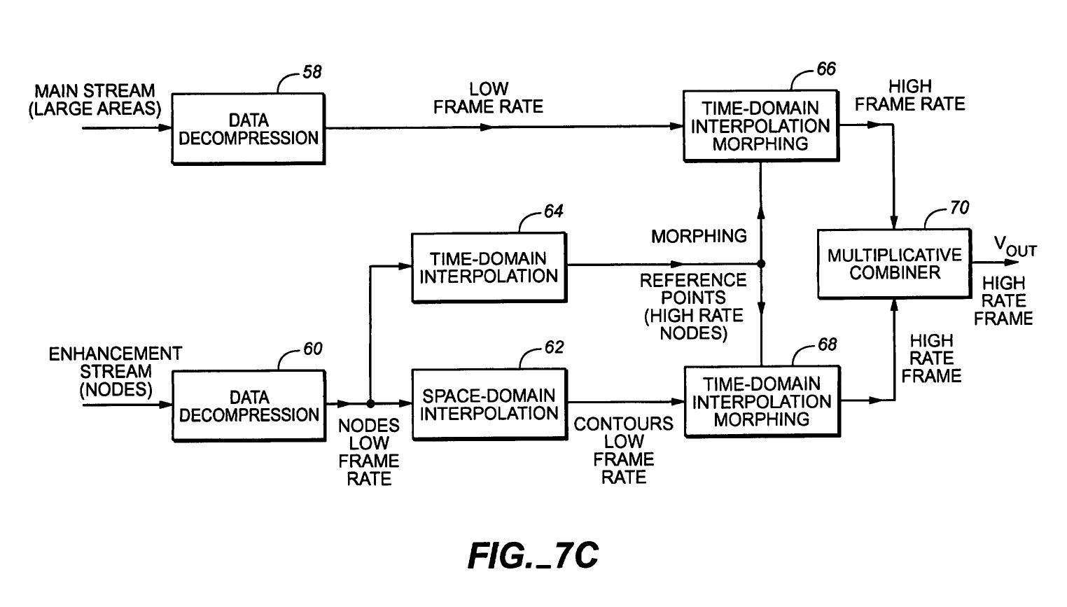

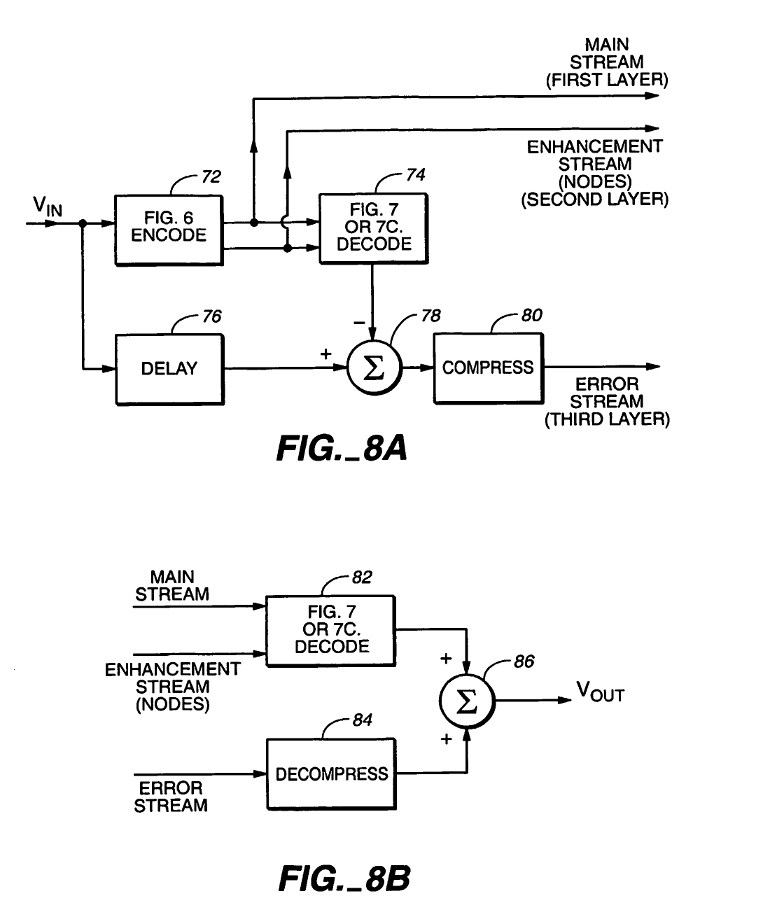

FIG. 7 shows a simplified conceptual and functional block diagram of a full-picture decoder or decoding function according to another aspect of the present invention. The decoder or decoding function of FIG. 7 is substantially complementary to the encoder or encoding function of FIG. 6. The main (large areas or low resolution) signal stream video signal input, received from any suitable recording or transmission is applied to a data decompressor or decompression function 32, which is complementary to block 30 of the FIG. 6 encoder or encoding function. As mentioned above, such data compression and decompression is optional. The output of block 32 is applied to a multiplicative or pseudo-multiplicative combiner or combining function 34, one possible implementation of which is described in detail below in connection with FIG. 7A.

The enhancement stream (nodes) video signal input, received from any suitable recording or transmission is applied to a data decompressor or decompression function 36. Block 36 performs the same functions as block 18 of FIG. 4B. As mentioned above, such data compression and decompression is optional. The output of block 36, a video signal representing recovered nodes at a low frame rate, is applied to a space-domain interpolator or interpolation function (contour recovery circuit or function) 38 and to a time-domain interpolator or interpolator function 37. Block 37 performs the same functions as block 20 of FIG. 4B although it is in a parallel path, unlike the series arrangement of FIG. 4B. Preferably, four-point time-domain interpolation is performed, as discussed above. Block 38 is similar to block 22 of FIG. 4B—it performs similar functions, but at a low frame rate, instead of the high frame rate of block 22 of FIG. 4B. Preferably, block 38 performs four-point space-domain interpolation, as discussed above. Block 37 generates a video signal representing nodes at a high frame rate in response to the video signal representing low frame rate nodes applied to it. The high frame rate nodes obtained from the video signal at the output of block 37 are used as key reference points to use for morphing (in block 40, described below) the low frame rate video from block 34 into high frame rate video.

The function of the multiplicative or pseudo-multiplicative combiner or combining function 34 is to enhance the low pass filtered large areas signal by the single pixel wide edge “marker” coming from the contour layer output of block 38. One suitable type of non-linear pseudo-multiplicative enhancement is shown in FIG. 7A, with related waveforms in FIG. 7B. In this exemplary arrangement non-linear multiplicative enhancement is achieved without the use of a multiplier—hence, it is “pseudo-multiplicative” enhancement. It generates, without multiplication, a transition-sharpening signal in response to first and second video signals, which transition-sharpening signal simulates a transition-sharpening signal that would be generated by a process that includes multiplication. The multiplier is replaced by a selector that shortens the first differential of a signal and inverts a portion of it in order to simulate a second differentiation that has been multiplied by a first differential (in the manner, for example, of U.S. Pat. No. 4,030,121, which patent is hereby incorporated by reference in its entirety). Such an approach is easier to implement in the digital domain (i.e., the avoidance of multipliers) than is the approach of the just-cited prior art patent. Furthermore, it has the advantage of operating in response to a single pixel, single quantizing level transition edge marker as provided by the contour layer. However, the use of a pseudo-multiplicative combiner of the type shown in FIG. 7A is not critical to the invention. Other suitable multiplicative or pseudo-multiplicative combiners may be employed.

Referring to FIGS. 7A and 7B, the large areas layer signal at point B (part B of FIG. 7B) from block 32 of FIG. 7 is differentiated in a first differentiator or differentiator function 42 (i.e., by “first” is meant that it provides a single differentiation rather than a double differentiation) to produce the signal at point D shown at part D of FIG. 7B. Waveform “D” is delayed and inverted in delay and inverter or delay and inverter function 46 to obtain waveform “E”.

The contour layer signal at point A (part A of FIG. 7B) from block 38 of FIG. 7 is applied to an instructions generator or generator function 48. The purpose of the instructions generator or generator function is to use the single bit, single pixel contour waveform marker “A” to generate a waveform “F” with 3 values, arbitrarily chosen here to be 0, −1, and +1. After proper delay in delay match or delay match function 50, waveform “F” (now “F′”) controls a selector or selector function 52 to choose one of the waveforms “D”, “E” or “0”. The selector operates in accordance with the following algorithm:

if F′=0 then G=0

if F′=−1 then G=E

if F′=+1 then G=D

The enhancement waveform G is then additively combined with the large area waveform B′ (properly delayed in delay or delay function 54) in additive combiner or combining function 56 to obtain a higher resolution image H.

A feature of one aspect of the invention is that if the enhancement path, or layer, is a video signal representing an image composed of contours, as it is here, the appropriate way to combine it with a video signal representing a low-resolution, gray-scale image is through a multiplicative process or a pseudo-multiplicative process such as the one just described. Prior art additive combiners employ two-layer techniques in which the frequency bands of the two layers are complementary. Examples include U.S. Pat. Nos. 5,852,565 and 5,988,863. An additive approach to combining the two layers is not visually acceptable if the enhancement path is composed of contours. Here, the large area layer and the enhancement layer are not complementary. If the layers were additively combined, the resulting image would be a fuzzy full color image with no discernible edges, onto which a sharp line drawing of the object is superimposed with color and gray levels of objects bleeding around the outline. In the best case, it would be reminiscent of watercolor paintings.

The output of the multiplicative or pseudo-multiplicative combiner or combining function 34 is a low frame rate video signal synchronized with the two inputs of block 34, which are themselves synchronized with each other. The time domain interpolation by morphing block 40 receives that low frame rate video signal along with the recovered nodes at a high frame rate of the video signal from block 37. Appropriate time delays (not shown) are provided in various processing paths in this and other examples.

The function of block 40 (FIG. 7) is to create intermediate frames located in the time domain in between two successive low frame rate video frames coming from block 34, in order to provide a video signal representing moving image. Such a function is performed by morphing from one low frame rate video frame to the next, the high frame rate nodes from block 37 being used as key reference points for this morphing. The use of key reference points for morphing is described in U.S. Pat. No. 5,590,261, which patent is hereby incorporated by reference in its entirety.

FIG. 7C shows a variation on the full-picture decoder or decoding function of FIG. 7. This variation is also complementary to the encoder or encoding function of FIG. 6. In the arrangement of FIG. 7, the video frame rate is increased using time-domain interpolation by morphing (using time-domain interpolated nodes as morphing reference points) after multiplicative or pseudo-multiplicative combining of the low frame rate large areas information and the low frame rate contours information. In the variation of FIG. 7C, the frame rate of the video signal representing large areas information and the frame rate of the video signal representing contours information are increased using time-domain interpolation by morphing (also using time-domain interpolated nodes as morphing reference points) prior to multiplicative or pseudo-multiplicative combining.

Refer now to the details of FIG. 7C, which shows a simplified conceptual and functional block diagram of a full-picture decoder or decoding function according to another aspect of the present invention. The main (large areas) signal stream input, received from any suitable recording or transmission is applied to a data decompressor or decompression function 58, which is complementary to the block and 30 of the FIG. 6 encoder or encoding function. As mentioned above, such data compression and decompression is optional. The enhancement stream (nodes) input, received from any suitable recording or transmission is applied to a data decompressor or decompression function 60. Block 60 performs the same functions as block 18 of FIG. 4B. As mentioned above, such data compression and decompression is optional. The output of block 60, a video signal representing recovered nodes at a low frame rate, is applied to a space-domain interpolator or interpolation function (contour recovery circuit or function) 62 and to a time-domain interpolator or interpolator function 64. Block 64 performs the same functions as block 20 of FIG. 4B although it is in a parallel path, unlike the series arrangement of FIG. 4B. Preferably, four-point time-domain interpolation is performed, as discussed above. Block 62 is similar to block 22 of FIG. 4B—it performs the same functions, but at a low frame rate, instead of the high frame rate of block 22 of FIG. 4B. Preferably, block 62 performs four-point space-domain interpolation, as discussed above. Block 64 generates a video signal representing nodes at a high frame rate in response to the video signal representing low frame rate nodes applied to it. The high frame rate nodes of the video signal obtained at the output of block 64 are used as key reference points to use for morphing (in blocks 66 and 68, described below) (a) the low-frame-rate low-resolution video from block 58 into high-frame-rate low-resolution video and (b) the low-frame-rate contours from block 62 into high-frame-rate contours, respectively. The function of each of blocks 66 and 68 is to create intermediate frames located in the time domain in between two successive low frame rate video frames coming from blocks 58 and 62, respectively, in order to provide a moving image. Such a function is performed by morphing between low frame rate video frames, the high frame rate nodes from block 64 being used as key reference points for this morphing. The use of key reference points for morphing is described in U.S. Pat. No. 5,590,261, which patent is hereby incorporated by reference in its entirety.

The high-frame-rate video signal outputs of blocks 66 and 68 are applied to a multiplicative or pseudo-multiplicative combiner 70, which functions in the same manner as multiplicative or pseudo-multiplicative combiner 34 of FIG. 7 except for its higher frame rate. As with combiner 34 of FIG. 7, the function of the multiplicative or pseudo-multiplicative combiner or combining function 70 is to enhance the high-frame-rate low-resolution large areas signal coming from the frame rate increasing block 66 by the single pixel wide edge “marker” coming from the contour layer output of block 62 the frame rate increasing block 68.

As mentioned above, optionally, a third layer may be used to transmit and correct errors of in the two-layer arrangements described above. This may be useful, for example, when the decoding is unable, because of some specific image complexity, to re-create the original picture. FIG. 8A shows a simplified conceptual and functional block diagram of an encoder or encoding function embodying such a further aspect of the present invention. FIG. 8B shows a simplified conceptual and functional block diagram of a decoder or decoding function complementary to that of FIG. 8A.

Referring first to FIG. 8A, the input video signal is applied to an encoder or encoding function 72 as in FIG. 6. Block 72 provides the main stream (constituting a first layer) and enhancement stream (nodes) (constituting a second layer) output video signals. Those output signals are also applied to complementary decoder 74 in the manner of the FIG. 7 or FIG. 7C decoder or decoding function in order to produce a video signal which is an approximation of the input video signal. The input video signal is also applied to a delay or delay function 76 having a delay substantially equal to the sum of the delays through the encoding and decoding blocks 72 and 74. The output of block 74 is subtracted from the delayed input signal in additive combiner 78 to provide a difference signal that represents the errors in the encoding/decoding process. That difference signal is compressed by a compressor or compression function 80, for example, in any of the ways described above, to provide the error stream output, constituting the third layer. The three layers may be recorded or transmitted in any suitable manner.

The decoder of FIG. 8B receives the three layers. The main stream layer and enhancement stream layer are applied to a decoder or decoding function 82 as in FIG. 7 to generate a preliminary video output signal. The error stream layer is decompressed by a decompressor or decompression function 84 complementary to block 80 of FIG. 8A to provide the error difference signal of the encoding/decoding process. The block 82 and 84 outputs are summed in additive combiner 86 to generate an output video signal that is more accurate than the output signal provided by the two-layer system of FIGS. 6 and 7.

Those of ordinary skill in the art will recognize the general equivalence of hardware and software implementations and of analog and digital implementations. Thus, the present invention may be implemented using analog hardware, digital hardware, hybrid analog/digital hardware and/or digital signal processing. Hardware elements may be performed as functions in software and/or firmware. Thus, all of the various elements and functions of the disclosed embodiments may be implemented in hardware or software in either the analog or digital domains.

1. A process for reducing the bandwidth or bit rate of a video signal representing an image, comprising
extracting edge transition components of the video signal representing contours of the image so as to reduce or suppress other components of the video signal, thereby providing a video signal mainly representing contours of the image, and
processing the video signal representing contours of the image so as to standardize one or more characteristics of the video signal components representing contours.

2. A process according to claim 1 wherein said processing includes processing the video signal representing contours so as to substantially standardize the amplitude of the video signal components representing contours by reducing or supressing amplitude magnitude variations and by suppressing polarity variations of components of the video signal representing contours.

3. (Cancelled)

4. A process according to claim 2 wherein said reducing or suppressing amplitude variations and suppressing polarity variations of components of the video signal representing contours comprises one-bit encoding of the components of the video signal such that a bit of having a value of 1 represents a transition and a bit having a value of 0 represents no transition or vice-versa.

5. A process according to claim 2 wherein said processing further includes processing the contour-amplitude-standardized video signal so as also to substantially standardize the characteristics of the video signal components representing the width of contours, so that the width of the contours of the image is substantially constant.

6. (Cancelled)

7. A process according to claim 6 wherein the video signal represents an image defined by pixels and wherein the substantially constant width of the contours is one pixel.

8. (Cancelled)

9. A process according to claim 2 wherein the video signal is a digital signal such that it represents an image defined by pixels further comprising bi-dimensionally filtering the contour-amplitude-standardized video signal to reduce or suppress single pixel edge transition components of the video signal.

10. (Cancelled)

11. (Cancelled)

12. A process according to claim 1, further comprising
extracting components of the contours-standardized video signal representing nodes along contours of the image so as to reduce or suppress other components of the video signal, thereby providing a video signal mainly representing nodes.

13. A process according to claim 12 wherein the video signal representing nodes has frames, the process further comprising lowering the frame rate of the video signal representing nodes.

14. (Cancelled)

15. (Cancelled)

16. (Cancelled)

17. A process according to claim 12 wherein components of the contour-standardized video signal representing nodes are extracted when the components represent one or more significant events occurring on a contour or its environment.

18. A process according to claim 17 wherein significant events include the start of the contour, the end of the contour, a significant change of curvature of the contour, a change in environment (gray level, color, texture) in the vicinity of the contour, and the distance from the prior node on given contour exceeding a pre-determined value.

19. A process according to claim 17 wherein components of the contour-standardized video signal representing a particular node are not extracted when the node location may be predicted through interpolation of the four adjacent consecutive nodes on the same contour.

20. (Cancelled)

21. (Cancelled)

22. (Cancelled)

23. A process according to claim 17 further comprising assigning a node attributes to components of the contour-standardized video signal representing node.

24. A process according to claim 23 wherein said node attributes include one or more of a node identifier, a contour identifier, spatial coordinates, and an identifier of the type of significant event giving rise to the node.

25. A process according to claim 23 wherein said video signal representing an image is a video signal having frames which represents a moving image, wherein the components of the contour-standardized video signal representing a particular node retain the same node attributes from frame to frame.

26. A process according to claim 12 wherein components of the contour-standardized video signal representing nodes are extracted at least in part by comparing the image represented by the video signal to images in a dictionary in which an entry in the dictionary is composed of an image and its associated nodes.

27. A process according to claim 26 wherein said video signal representing an image is a video signal having frames which represents a moving image, wherein the dictionary includes sequences of images, including their associated nodes, undergoing common types of motion.

28. A process according to claim 12 wherein components of the contour-standardized video signal representing nodes are extracted by reference to physical indicators affixed to the object represented by the video signal.

29. A process according to claim 17 wherein the components of the contour-standardized video signal representing nodes are ranked according to a hierarchy, whereby bandwidth adaptivity may be achieved by ignoring signal components representing less significant nodes.

30. (Cancelled)

31. (Cancelled)

32. A process for deriving a video signal having frames in which each frame mainly represents contours of a moving image in response to a video signal having frames in which each frame mainly represents nodes of a moving image, comprising
time-domain interpolating the video signal in which each frame represents nodes to increase the frame rate of the video signal, and
space-domain interpolating the frame increased video signal to provide a video signal mainly representing contours of the moving image.

33. (Cancelled)

34. A process according to claim 32 wherein either or both of said time-domain interpolating and said space-domain interpolating employs four-point interpolation.

35. (Cancelled)

36. (Cancelled)

37. (Cancelled)

38. (Cancelled)

39. (Cancelled)

40. (Cancelled)

41. (Cancelled)

42. (Cancelled)

43. A process for reducing the bandwidth or bit rate of a video signal representing an image, comprising
extracting edge transition components of the video signal representing contours of the image so as to reduce or suppress other components of the video signal, thereby providing a video signal mainly representing contours of the image,
extracting components of the contours video signal representing nodes along contours of the image so as to reduce or suppress other components of the video signal, thereby providing a video signal mainly representing nodes, and
extracting components of the video signal representing large areas of the image so as to reduce or suppress components of the video signal representing contours of the image, thereby providing a video signal mainly representing a low-resolution, substantially contour-free version of the image.

44. A process according to claim 43 wherein extracting edge transition components of the video signal representing contours includes standardizing one or more characteristics of the video signal components representing contours.

45. (Cancelled)

46. (Cancelled)

47. (Cancelled)

48. (Cancelled)

49. A process according to claim 43 further comprising reducing the frame rate of the video signal representing nodes and reducing the frame rate of the video signal representing a low-resolution substantially contour-free version of the image.

50. (Cancelled)

51. A process for generating a video signal which is an approximation of a video signal representing an image, comprising
receiving a first video signal mainly representing the contours of the image, wherein signal components representing contours in said first video signal have one or more standardized characteristics that include reduced or suppressed amplitude variations and suppressed polarity variations so that the width of contours is substantially constant,
receiving a second video signal mainly representing a low resolution, substantially contour-free version of the image from which said contours were derived, and
combining said first and second video signals to generate the approximation video signal.

52. (Cancelled)

53. (Cancelled)

54. (Cancelled)

55. (Cancelled)

56. (Cancelled)

57. (Cancelled)

58. (Cancelled)

59. A process for deriving a video signal in response to a first video signal having frames mainly representing nodes of a moving image and a second video signal having frames mainly representing a low resolution version of the moving image from which the nodes were derived, comprising
space-domain interpolating the first video signal to provide a video signal mainly representing contours of the image,
time-domain interpolating the first video signal to provide an increased frame rate version of the first video signal,
combining said video signal representing contours with said second video signal to provide a third video signal, and
increasing the frame rate of the third video signal by generating intermediate frames by morphing between frames of the third video signal using the high frame rate nodes of the increased frame rate version of the first video signal as reference points.

60. A process according to claim 59 wherein either or both of said time-domain interpolating and said space-domain interpolating employs four-point interpolation.

61. (Cancelled)

62. (Cancelled)

63. A process for deriving a video signal in response to a first video signal having frames mainly representing nodes of a moving image and a second video signal having frames mainly representing a low resolution version of the moving image from which the nodes were derived, comprising
space-domain interpolating the first video signal to provide a video signal mainly representing contours of the image,
time-domain interpolating the first video signal to provide an increased frame rate version of the first video signal,
increasing the frame rate of the video signal representing contours of the image by generating intermediate frames by morphing between frames of the video signal using the high frame rate nodes of the increased frame rate version of the first video signal as reference points,
increasing the frame rate of the second video signal by generating intermediate frames by morphing between frames of the second video signal using the high frame rate nodes of the increased frame rate version of the first video signal as reference points, and
combining the increased frame rate video signal representing contours of the image with the increased frame rate second video signal.

64. A process according to claim 63 wherein either or both of said time-domain interpolating and said space-domain interpolating employs four-point interpolation.

65. (Cancelled)

66. (Cancelled)

67. An encoding process for reducing the bandwidth or bit rate of an input video signal representing an image, comprising
extracting components of the video signal representing large areas of the image so as to reduce or suppress components of the video signal representing contours of the image, thereby providing a video signal mainly representing a low-resolution, substantially contour-free version of the image, the video signal representing a low-resolution, substantially contour-free version of the image constituting a layer output of the encoding process,
extracting edge transition components of the video signal representing contours of the image so as to reduce or suppress other components of the video signal, thereby providing a video signal mainly representing contours of the image,
extracting components of the contours video signal representing nodes along contours of the image so as to reduce or suppress other components of the video signal, thereby providing a video signal mainly representing nodes, the video signal representing nodes constituting a further layer output of the encoding process
processing said video signal representing contours of the image and said video signal representing a low-resolution, substantially contour-free version of the image to produce a video signal approximating the input video signal, and
subtractively combining the input video signal and the video signal approximating the input video signal to produce an error signal, the error signal constituting yet a further layer output of the encoding process.

68. (Cancelled)

69. (Cancelled)

70. (Cancelled)

71. (Cancelled)

72. A process for deriving a video signal in response to a first video signal representing nodes which in turn represent an image, a second video signal representing a low resolution version of the image from which said nodes were derived, and a third signal representing the difference between a video signal representing an image from which said first video signal and said second video signal were derived and an approximation of the video signal representing an image from which said first video signal and said second video signal were derived, comprising
space-domain interpolating the first video signal to provide a video signal representing contours of the image, and
combining said video signal representing contours with said second video signal to produce a video signal which is substantially the same as said approximation of the video signal representing an image from which the first video signal and the second video signal were derived, and
combining the video signal which is substantially the same as said approximation of the video signal representing an image from which the first video signal and the second video signal were derived with the error difference signal to provide a video signal which is more closely an approximation of the video signal representing an image from which said first video signal and said second video signal were derived.

73. A process for providing a video signal approximating a video signal representing an image from which a first video signal and a second video signal were derived, the first video signal mainly representing the contours of an image, wherein said contours have standardized characteristics, and said second video signal mainly representing a low resolution, substantially contour-free version of the image from which said contours were derived, comprising
receiving said first video signal,
receiving said second video signal,
generating, without multiplication, a transition-sharpening signal in response to said first and second video signals, which transition-sharpening signal simulates a transition-sharpening signal that would be generated by a process that includes multiplication, and
additively combining said transition-sharpening signal with said second video signal to provide a video signal approximating said video signal representing an image from which a first video signal and a second video signal were derived.

74. A process according to claim 73 wherein the amplitudes and widths of said first video signal have standardized characteristics.

75. A process according to claim 73 wherein said generating includes:
applying a single differentiation to the second video signal to produce a third video signal,
delaying and inverting the third video signal to produce a fourth video signal, and
generating said transition sharpening signal by selecting a portion of said third video signal and a portion of said fourth video signal in response to a switching signal derived from said first video signal.
